(19) United States
(12) Patent Application Publication
(10) Pub. No.: US 2026/0161693 A1
(43) Pub. Date: Jun. 11, 2026

(54) SELECTIVE AND PERSONALIZED ACQUISITION OF USER DATA USING ADAPTIVE LEARNING

(71) Applicant: PAYPAL, INC., San Jose, CA (US)

(72) Inventors: Chun Kiat Ho, Singapore (SG); Luke Rennison, MacPherson (SG); Vipul Jain, Singapore (SG); Savitha Ajitraj, Chennai (IN); Gopalakrishnan Srinivasan Ramarajan, Singapore (SG)

(21) Appl. No.: 18/975,608

(22) Filed: Dec. 10, 2024

(51) Int. Cl. G06F 16/335; G06F 3/0481; G06F 16/31

(52) U.S. Cl. CPC G06F 16/337; G06F 3/0481; G06F 16/322

(57) ABSTRACT

There are provided systems and methods selective and personalized acquisition of user data using adaptive learning. An online transaction processor or other service provider may provide computing services and products to users and entities. For data collection required for computing service and/or product provision, users may be provided with selected data fields in dynamically created and customized UIs based on rules for data requirements and collection. The rules may be generated from policies of the service provider, which may be converted to conditional trees using an AI model and natural language processor. The trees may be merged based on shared conditions, and the rules may indicate what data may be collected for a specific service or product, as well as what other services or products may utilize overlapping data collection. As such, the data fields may be selectively chosen by an AI engine during data collection.

### TECHNICAL FIELD

The present application generally relates to data acquisition through user interfaces (UIs) and data collection operations, and more particularly to selectively acquiring user data based on intelligently created rules for adaptive learning engines.

### BACKGROUND

Online service providers may offer various services to end users, merchants, and other entities. This may include providing electronic transaction processing, account services, and other computing services and platforms. Further, the service provider may provide and/or facilitate the use of online merchant marketplaces and/or transaction processing between different users and entities. However, establishment and use of these digital services require customers, merchants, and other users and/or entities to onboard with the service providers. During onboarding and/or data collection operations, services may not be streamlined to prevent users from performing unnecessary data input and/or engaging in duplicate data entry and inputs. This creates unnecessary manual processes and duplicates data, wasting system resources from processing, verifying, and storing such data. As such, conventional data collection results in inefficient usage of system resources and unnecessary user inputs and efforts. Thus, there is a need to provide a more streamlined, faster, and more efficient data acquisition and collection.

### BRIEF DESCRIPTION OF THE DRAWINGS

FIG. 1 is a block diagram of a networked system suitable for implementing the processes described herein, according to an embodiment;

FIGS. 2A-2D are exemplary diagrams for configuring data fields for data collection in a user interface for selection and personalized acquisition of user data, according to an embodiment;

FIG. 3 is an exemplary user interface having data fields configured to collect and acquire user data in a selective and personalized manner using adaptive learning, according to various embodiments;

FIG. 4 is a flowchart for selective and personalized acquisition of user data using adaptive learning, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for selective and personalized acquisition of user data using adaptive learning. Systems suitable for practicing methods of the present disclosure are also provided.

To utilize the computing services of online service providers, such as electronic transaction processors that may provide merchants and customers with digital accounts for payment processing, users may be required to onboard with the service providers and proceed through data collection processes for user verification and the like. Users may correspond to individual customers or end users, as well as employees, owners, agents, etc., of merchants or other entities. As such, during data collection processes, users may be required to input, upload, and/or verify requested data. However, data collection processes may not be streamlined to prevent users from performing unnecessary data input and/or repetitive activities. This creates duplications of data and processing requests and unnecessarily burdens users with repetitive inputs and unnecessary UI flows. Users become burdened with additional manual inputs and wasted time, and computing systems may be adversely affected by storing duplicate data and/or executing repeated processing tasks and operations when those have previously been performed.

For example, trusted users and/or merchants of an online transaction processor (e.g., those users and/or merchants that utilize the online transaction processor for electronic transaction processing and have been verified and trusted based on past experiences, usage, risk analysis, etc.), may be required to proceed through data collection that collects data that is already known and/or stored, which is unnecessary and wasteful of system resources. However, conventional data collection requirements are rigid and need human intervention to configure data collection UIs and fields, rules for data collection policies, and outcomes of data collection and processing, which leads to developers generating “one-size-fits-all” solutions with static data collection processes and UIs with standardized fields. This rigidity further prevents processes to collect other data that may be useful to the user and/or merchant, as well as offer or promote computing services and/or products that may be of interest and are available based on the collected data. Thus, these difficulties of conventional data collection for users and merchants may lead to loss of customer reliance, data security issues, and/or attrition.

Data collection is needed when users, including merchants or customers, may wish to process a transaction, such as for a payment to another user or a transfer, through an online service provider. The user may request processing of one or more transactions using a digital wallet or other account with the online service provider or transaction processor (e.g., PayPal®), which may require onboarding for such accounts, as well as for user and merchant services, financial instruments, and the like. In order for merchants to provide services for users to engage in these processes and interactions for processing transactions with the merchants, the service provider may provide operations for onboarding and/or data collection to verify users for accounts, transaction processing operations, and other products and computing services. For example, when accessing online platforms and utilizing the corresponding computing resources of a service provider, such as the aforementioned transaction processor, users and merchants may onboard with the service provider to obtain access to accounts and computing services and utilize corresponding services for payment processing, or otherwise enter a data collection process via one or more UIs. The onboarding and/or data collection user experience (UX) via these UIs is often a time consuming and difficult process requiring many data inputs, uploads, computing service setups (including software development kit (SDK) usage and setup), application and/or website setup and configuration, and the like.

Since data collection processes conventionally provide static UIs and UXs, users become burdened with additional manual inputs and time wasted with entering unnecessary data, which may also impact computing systems by storing duplicate data and/or executing repeated processing tasks and operations even when data and corresponding users/accounts have previously been obtained, processed, and/or verified. In various embodiments, an online transaction processor or other service provider may make the data collection UX more friendly, efficient, and personalized using dynamically configured UXs and data collection fields for submissions that promote computing services and other products based on collected data. For example, the service provider may provide customized and intelligently created rules from policies for different products, computing services, and/or requirements of the service provider. These policies may be used for a rule generation and synthesis engine that intelligently generates rules that merge data collection requirements across policy mandates based on individual merchants, users, and/or market-specific needs.

Based on these rules, during data collection, computing services and other products for which users and/or merchants are eligible may be offered based on data already collected, as well as products that the users and/or merchants may need based on their existing patterns and/or similar rule overlap. The rules allow for intelligently categorizing customer or user profiles for tiering and adjustment of data collection requirements. Additionally, the rules may allow for customization and experimentation of different customer experiences for data collection and onboarding, as well as adapting UXs for data collection and onboarding depending on local or regional regulatory requirements and allowing for updates and adjustments based on changes to those requirements.

The system may use the rules with data about the customer (e.g., end users, merchants, and the like) including a customer profile, customer activity, and customer products. The system also has access the entire product catalog from which the system may determine suggestions/recommendations. This system has various components including a conditional tree builder, conditional trees, logic tree merger, and data and product recommendations. Since the output of each policy information point (PIP) system is to provide information about the policies that are hosted within that system, that information is converted into a standardized language. Conditional trees are helpful in this task as the collection rules have conditions and dependencies inbuilt, and, as such, the policies may be converted to standard conditional trees in a standardized language and having conditions for data requirements and the corresponding data required when those conditions are met or occur.

A logic tree merger may then be used to merge standardized language trees into merged trees based on their conditions and data. The complexity to be handled is that each tree may have different depths, conditions and the way conditions are written, which requires intelligent processing and understanding of the trees for merging. Once merged, the rules may be used to recommend data submissions and data fields to collect data required from users for data collection and/or onboarding. As such, the data and product recommendation component may be responsible for recommending which data is more suited for the customer given their current situation and prescribed policies. The component may replace weaker data points with stronger data points; and make smarter recommendations. The data recommendations may work in conjunction with product recommendations, so that the component may also make suggestions to the customer about additional products that are available and how useful they are for or the value provided to them. This may also show how easily customers can onboard with the data that they are providing and/or has been collected. As such, the component may provide a combination of user-based collaborative filtering but also data-based knowledge of which incremental data can enable more relevant products to be provided for the customer. To do so, a data correlation analyzer may be used that may act as a real-time component for monitoring customer profiles and data collection to determine available data from different data sources and the correlation between such sources for data collection.

In this regard, an AI engine and system may include one or more AI models, such as machine learning (ML) models, neural networks (NNs), or the like, to determine data fields for data collection in a UI and via a UX for a user. This may be done through the rule synthesis of rules from policies based on the conditional tree generation and merger. Training of the AI may be performed using the rules and/or the available computing services and/or products of the service provider. During training of an AI model, the model may be trained to make predictions and recommendations based on the collected and/or available user data, the user data needed from the user, the rules for data collection, and the like. As such, the rules may be used to generate, in real-time and during data collection processes, data collection fields for a configured UI and/or UIs that provide a personalized and customized data collection process. The rules may be intelligently generated using an AI engine based on the conditional tree generation and merger and may drive the data fields, UIs, and UI elements for data collection recommendations, as well as product recommendations based on collected data. The AI engine may therefore implement an adaptive learning technique and process to customize a data collection process and interaction for customized resources and learning or data collection processes.

Consequently, a service provider may provide an improved data collection system for optimized data collection for different computing services, which may be required by different data collection policies. This may reduce the repetitive data entry caused by conventional data collection systems. With these conventional systems, there are many valid reasons for users and/or their corresponding merchants or other entities to drop off from onboarding and/or data collection processes. Gaps from integration, complex workflows, and processes that create tension and friction with onboarding of accounts and services may lead to loss of merchant onboarding and/or poor UXs of the merchants. Further, existing platforms often struggle with scalability, particularly when handling different products with varying eligibility criteria.

In contrast, the data collection system and processes described herein to implement an intelligent rule generation and data collection process and field customization may provide personalized data collection UIs and fields, while remaining scalable for production computing environments. The system ensures efficient data collection process, as well as cross-promotion of related or suggested products and services based on collected data. In contrast, conventional onboarding systems do not have a sophisticated method for pre-verifying merchants before they apply for a product, leading to increased risk and potential fraud. The AI engine and rules may evaluate data collection processes in real-time as users engage in use of computing services and platforms to make intelligent recommendations of data fields to present to users, and auxiliary computing services and products that may be provided based on the data collected or to be collected. This proactive data collection process may therefore simplify data collection and processing, making the processes more efficient and tailored for specific users and purposes, thereby providing a more efficient, optimized, and tailored solution to data collection requirements.

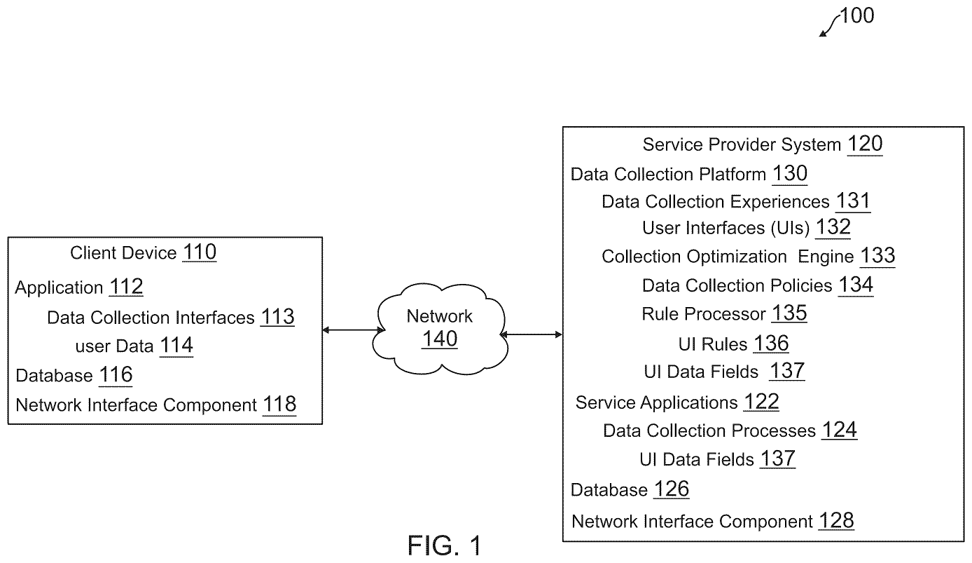

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110 and a service provider system 120 in communication over a network 140. Client device 110 may be utilized by a user to receive communications over network 140, where service provider system 120 may provide various data, operations, and other functions over network 140 to provide services to users, entities, and their corresponding computing devices. In this regard, client device 110 may be used to provide data during a data collection process by service provider system 120, such as when onboarding for use of a computing service or product. Service provider system 120 may provide specifically configured UIs and UXs for specific data collection fields that may be suitable for the current data requirements, available data for the user, and matching products for the user, as discussed herein.

Client device 110 and service provider system 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device that may utilize appropriate hardware and software configured for wired and/or wireless communication with service provider system 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. Application 112 may correspond to executable processes, procedures, and/or applications with associated hardware. In other embodiments, client device 110 may include additional or different modules having specialized hardware and/or software as required.

In some embodiments, application 112 may correspond to one or more processes to execute software modules and associated components of client device 110 to provide features, services, and other operations by a customer or other user, including users of entities (e.g., businesses including merchants and the like) over network 140, to engage with computing services and products of service provider system 120. In this regard, application 112 may be used to engage with data collection processes for onboarding, user identification and/or authentication/verification, product usage, and the like with service provider system 120, for example, for an account, payment and/or electronic transaction processing services, and other computing services provided through data collection interfaces 113.

Application 112 may be utilized by a user on client device 110 to access websites and/or application data and display such data allowing interaction with and/or navigation between webpages and/or application interfaces and other data. In some examples, application 112 may be used to provide transaction processing for products, such as through a user interface enabling the user to enter and/or view the products that the user associated with client device 110 wishes to purchase. This may be based on transactions generated by application 112 using one or more merchant websites and/or marketplaces, where use of accounts, computing services, and other products may require data submission via data collection interfaces 113 of user data 114, which can include merchant data or data associated with other users of service provider system 120.

To process transactions, application 112 may utilize user financial information, such as credit card data, bank account data, or other funding source data, as a payment instrument when providing payment information. Additionally, application 112 may utilize a digital wallet associated with an account with service provider system 120 as the payment instrument, for example, through accessing a digital wallet or account of a user through entry of authentication credentials and/or by providing a data token that allows for processing using the account. Application 112 may also be used to receive a receipt or other information based on transaction processing. However, different services may be provided via application 112, including social networking, media posting or sharing, microblogging, data browsing and searching, online shopping, and other services available through service provider system 120. Thus, application 112 may also correspond to different service applications and the like.

When engaging with service provider system 120 and/or another website, application, or platform that may utilize the computing services of service provider system 120 (e.g., for accounts, electronic transaction processing, risk, etc.), service provider system 120 may require collection and acquisition of user data 114 for user verification or other purposes including underwriting, regulatory compliance, risk or fraud including anti-money laundering, and the like. As such, data collection interfaces 113 may be presented on client device 110 in application 112, which may request input of user data 114 via one or more UI fields. The UI fields and/or data collection interfaces 113 may be specifically customized and/or tailored depending on rules for data requirements and collection of service provider system 120, as well as the previously collected data and predicted products and/or services that may be of interest to the user and/or that the user may qualify or is eligible for. This allows data collection interfaces 113 to collect data in a more efficient and optimized manner for user data 114, which may be used for the computing service or other product requested and/or other eligible products for the user.

Application 112 may correspond to a general browser application and/or general, native, or local software application including mobile applications that may be configured to retrieve, present, and communicate information over the Internet (e.g., utilize resources on the World Wide Web) or a private network. For example, application 112 may provide a web browser, which may send and receive information over network 140, including retrieving website information (e.g., a website for an email provider or other messaging service), presenting the website information to the user, and/or communicating information to the website. Application 112 may include a dedicated application provided by service provider system 120. Application 112 may be associated with digital payment accounts, account information, user financial information, and/or transaction histories, which may be associated with electronic transaction processing services provided by service provider system 120 for merchants.

Client device 110 may further include or have access to database 116, which may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider system 120.

Client device 110 includes at least one network interface component 118 adapted to communicate with service provider system 120 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider system 120 may be maintained, for example, by an online service provider, which may provide computing services and operations via one or more digital platforms, applications, websites, and the like. Service provider system 120 may provide computing services to various entities, which may require user data for data collection process that request data that may be used for authentication, verification, or other purposes. These data collection processes may correspond to data requirements of computing services and other products of service provider system 120, and as such, may be determined based on policies for data collection and rules generated from conditional trees created of the policies. In one example, service provider system 120 may be provided by PAYPAL®, Inc. of San Jose, CA, USA. However, in other embodiments, service provider system 120 may be maintained by or include another type of service provider.

Service provider system 120 of FIG. 1 includes and/or is associated with a data collection platform 130, service applications 122, a database 126, and a network interface component 128, implementations of which are discussed further below. Data collection platform 130 and service applications 122 may correspond to executable processes, procedures, and/or applications with associated hardware. In other embodiments, service provider system 120 may include additional or different modules having specialized hardware and/or software as required.

Data collection platform 130 may correspond to one or more processes to execute modules and associated specialized hardware of service provider system 120 to provide selective and personalized data collection and acquisition from users during processing flows and with UIs based on procedurally generated rules and adaptive learning techniques. In this regard, data collection platform 130 may correspond to specialized hardware and/or software used by a user associated with client device 110 to provide operations for onboarding and/or data collection via one or more UIs, such as to open and/or utilize an account, electronic transaction processing service, communication or messaging, risk and/or fraud, or other computing service provided by service provider system 120. For example, data collection platform 130 may be used to specifically configure data collection experiences 131 having UIs 132 based on available, previously entered, and/or required data so that data collection experiences 131, such as a UX provided through one or more processing flows, may selectively acquire user data for specific data requirements based on policies and additional computing services or other products that may be relevant or of interest to the user. UIs 132 may include data for a processing flow and data collection process through one or more UI elements (e.g., data forms, menus, information, windows, selectable options, etc.) with corresponding data fields for user input and/or data entry (e.g., via manual input, upload, linking to a data source, enabling access to a data source or account, etc.). This may correspond to a UX for onboarding, requesting use of a product, verifying or authenticating for access to the product, and the like.

In this regard, data collection platform 130 may utilize data collection experiences 131 having UIs 132 when a user, such as a customer, merchant, or other single user or entity, accesses service provider system 120 and enters or engages a processing flow requiring submission of user data for processing, verification, and the like. For example, with users, a user may enter an account establishment process or verify their identity for increased daily limits on transaction processing, transfers, and the like, which may require the user to input personally identifiable information (PII), financial data, and the like. With merchants, onboarding for an account and/or computing service that provides the merchant with electronic transaction processing services via their digital platform may require the merchant to proceed through a risk analysis, underwriting, and/or trust rating of the merchant. The user may specifically be engaging with a certain product, but other related products or products of interest may be offered based on the data being collected and the data requirements of those products. As such, offers for onboarding and/or provision of other products may be provided based on the data collected, being collected, and/or that may be required through UIs during data collection experiences 131.

Data collection experiences 131 may correspond to UXs for an onboarding and/or data processing flow that may acquire and process data, such as user or merchant data, to determine a user's and/or merchant's eligibility to onboard and access, receive, and/or use a computing service or product of a service provider corresponding to service provider system 120. In this regard, data collection experiences 131 may be customizable and dynamically configured for the user and/or merchant of a corresponding onboarding process and experience. As such, UIs 132 may be selectively configured and optimized for data collection by collection optimization engine 133 based on rules synthesized procedurally from data collection policies 134. Data collection policies 134 may be associated with risk, authentication or authorization, compliance, legal, underwriting, KYC, or other policies, requirements, or guidance for service provider system 120 and/or regarding the computing service and/or product to be provided.

As such, UIs 132 may include one or more UI elements from a buildable component factory of UI elements or the like for creation of UIs 132 for changing, configuring, and personalizing UI layout and data field presentation for data collection. This may include collection optimization engine 133 changing, updating, or configuring UIs 132 and/or series of flows of UIs for data collection based on their fields, menus, informational fields, options, navigation tools or links, and or elements. Collection optimization engine 133 includes a rule processor 135 for generation of UI rules 136 based on data collection policies 134 and available data for the user and/or entity being onboarded or for which data is being collected. Available data may include user, merchant, and/or entity-specific data that may have been previously acquired and/or generated or may otherwise preexist with service provider system 120 or is accessible to service provider system 120. Rule processor 135 may include an AI model to synthesize UI rules 136 from data collection policies 134 of service provider system 120, where data collection policies 134 may include a risk management policy, an authentication or authorization policy, a user verification policy, a product usage policy, or a legal compliance policy. Data collection policies 134 may be accessible from a repository of policies that may be collected, configured, and/or updated. UI rules 136 may be created for data collection that may be required for specific computing services and products based on data collection policies 134.

To create UI rules 136 from data collection policies 134, rule processor 135 may initially parse and/or process data collection policies 134 for the required inputs for data collection and convert those to conditions and requirements in hierarchical branches. This allows for creation of individual requirement trees that have conditions, or conditional trees for data collection. Conditional trees generated by rule processor 135 may therefore have conditions for collecting data in accordance with the data requirements of data collection policies 134 for the corresponding computing service or product that the user is requesting and/or providing data. In this regard, each condition may have one or more dependencies on certain data to be provided to satisfy the corresponding data requirement(s).

As such, conditional trees may be generated from data collection policies 134 as single trees that have conditions. Rule processor 135 may then generate merged conditional trees for rule synthesis and generation by comparing conditions (e.g., based on subject, predicate, value, etc.), and identifying the same or similar overlapping conditions. Rule processor 135 may then merge the trees, and from the merged trees, may generate UI rules 136. UI rules 136 may be utilized with an AI engine of collection optimization engine 133 that implements adaptive learning to customize UI data fields 137 for UIs 132. For example, based on UI data fields 137 that have already been completed or data has been collected, and which of UI data fields 137 are still pending for data entry, UIs 132 may be customized for data entry. Customization of UI data fields 137 may be done to streamline data entry and collection, as well as reduce unnecessary data inputs. Furthermore, UI data fields 137 may be customized to collect data necessary for product recommendations and/or similar products or products of interest to a user based on their previously provided data. UI data fields 137 may be output in a customized and personalized manner in service applications 122.

An AI engine for collection optimization engine 133 and/or rule processor 135, which may be used for selection and personalization of UI data fields 137 and/or generation of UI rules 136, respectively, may include one or more AI or ML models, NNs, conversational AIs, or the like. AI models may have trained layers based on training data and selected features or data variables configured for data collection process inferencing, such as rule generation and/or data field selection. For example, ML features or variables may correspond to individual pieces, properties, characteristics, or other inputs for an ML model and may be used to cause an output by that ML model once the ML model has been trained using data for those features from training data. AI models may be used for computation and calculation of model scores based on layers, nodes, branches, clusters, rules, and the like that are trained and optimized. As such, ML models may be trained to provide a predictive output, such as a score, likelihood, probability, or decision, associated with a particular prediction, classification, or categorization.

AI models may include DNNs, MLs, LLMs, generative AIs, or other AI models trained using training data having data records that have columns or other data representations and stored data values (e.g., in rows for the data tables having feature columns) for the features. When building AI models, training data may be used to generate one or more classifiers and provide recommendations, predictions, or other outputs based on those classifications and an ML or NN model algorithm and architecture. The algorithm and architecture for the AI models may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different output value based on the input values. The values generated by the hidden layer nodes may be used by the output layer node(s) to produce one or more output values for ML models that attempt to classify and/or categorize the input feature data and/or data records. Thus, when the AI models are used to perform a predictive analysis and output, the input data may provide a corresponding output based on the trained classifications.

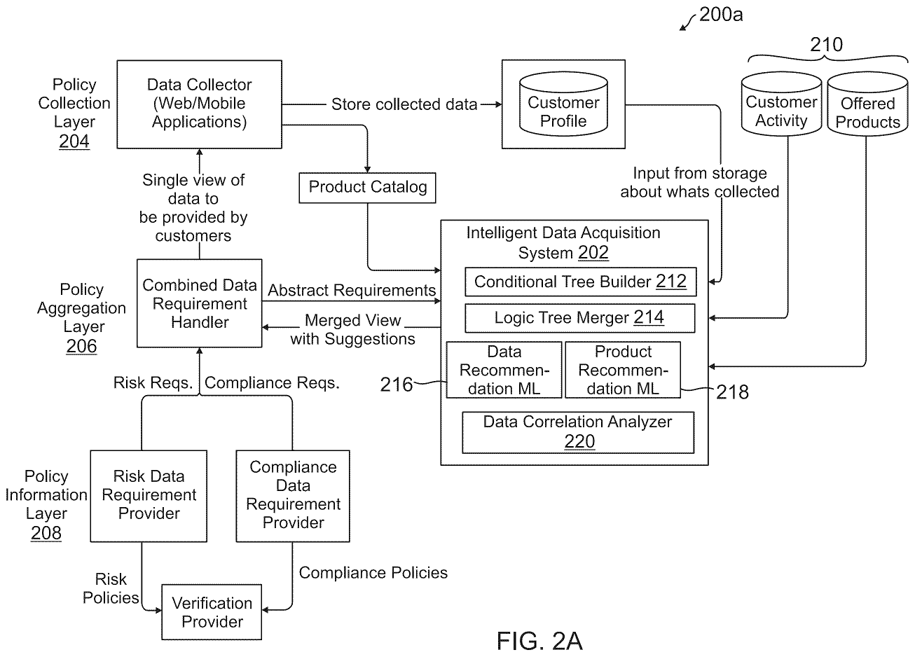

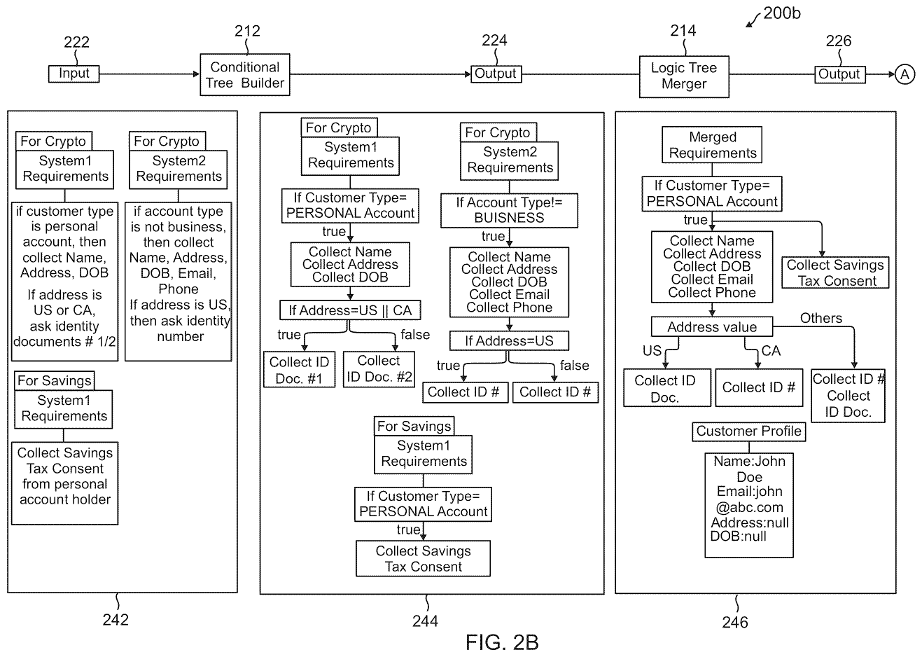

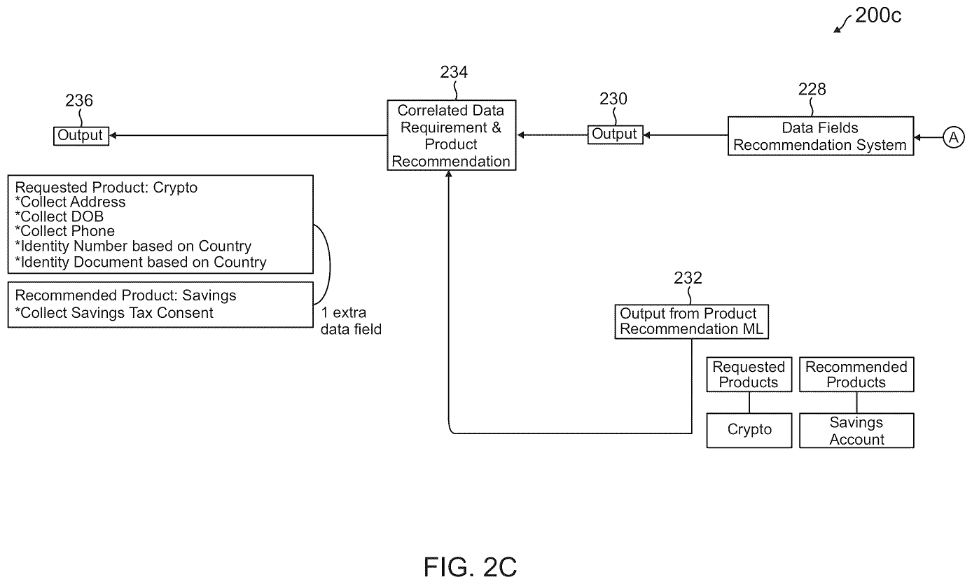

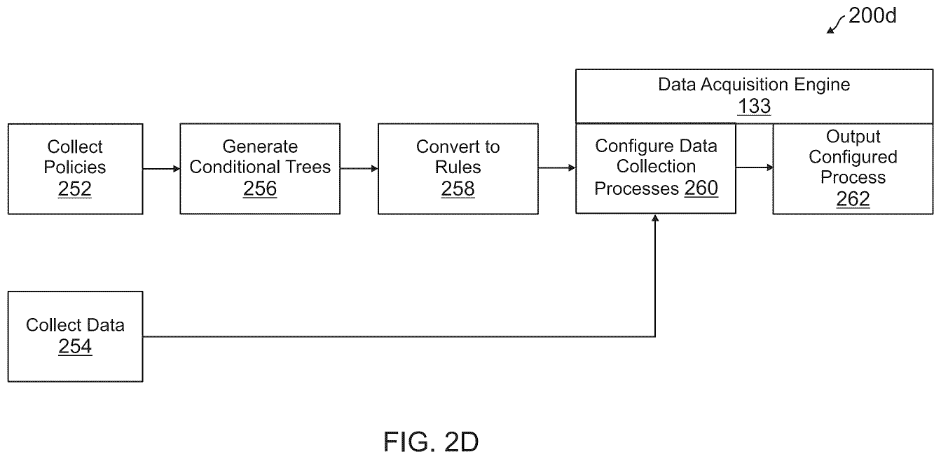

Layers, branches, clusters, or the like of the AI models may be trained by using training data associated with data records of interest, such as onboarding options, computing services, personalized assistance responses, available and/or required data for onboarding tasks and goals, and the like. By providing training data, the nodes in the hidden layer may be trained (adjusted) such that an optimal output (e.g., a classification) is produced in the output layer based on the training data. By continuously providing different sets of training data and/or penalizing the AI models when the outputs are incorrect, the AI models (and specifically, the representations of the nodes in the hidden layer) may be trained (adjusted) to improve its performance in data classifications and predictions. Adjusting of the AI models may include adjusting the weights associated with each node in the hidden layer. The operations for rule generation through conditional tree merger and UI field selection for personalized data collection using adaptive learning are discussed in further detail with regard to FIGS. 2A-4 below.

Service applications 122 may correspond to one or more processes to execute modules and associated specialized hardware of service provider system 120 to process a transaction and/or provide other computing services to users. For example, service applications 122 may include a transaction processing application used to process payments and other services to one or more users, merchants, and/or other entities for transactions, where users may provide data for use of the transaction processing application or other services applications through data collection processes 124 for data collection experiences 131. In this regard, data collection processes 124 may have UI data fields 137 configured and provided based on adaptive learning techniques and models that utilize UI rules 136 for data collection. For example, an account may be used to send and receive payments, including those payments that may be enabled on digital platforms and/or in-person at POS devices and other payment terminals. A payment account may be accessed and/or used through a browser application and/or dedicated payment application executed by client device 110, such a payment and/or digital wallet application. The transaction processing application may process payments and may provide transaction histories to client device 110 and/or another user's device or account for transaction authorization, approval, or denial of the transaction for release of the funds, including transfer of the funds between accounts.

Further, service applications 122 may provide different computing services, including social networking, microblogging, media sharing, messaging, business and consumer platforms, etc. These computing services may be used by users or entities, where data collection for service usage and provision may be performed through data collection processes 124. As discussed herein, data collection processes 124 may include UI data fields 137 selectively configured and utilized by collection optimization engine 133 based on UI rules 136. UI rules 136 may be used to determine, from completed data fields, previously provided data, and the like, additional ones of UI data fields 137 necessary for data requirements for computing service or product use, provision, or the like, as well as promotion and offer of other computing service and products that may be related, similar, of interest, or the like. As such, service applications 122 may present one or more of UI data fields 137 specifically for certain users for data collection of user data during use of data collection processes 124.

Service applications 122 further may provide additional features to service provider system 120 for internal and/or external applications, websites, systems, processors, and the like. For example, service applications 122 may include security applications for implementing server-side security features, programmatic client applications for interfacing with appropriate application programming interfaces (APIs) over network 140, or other types of applications. Service applications 122 may contain software programs, executable by a processor, including one or more GUIs and the like, configured to provide an interface to the user when accessing service provider system 120, where the user or other users may interact with the GUI to view and communicate information more easily. Service applications 122 may include additional connection and/or communication applications, which may be utilized to communicate information to over network 140.

Additionally, service provider system 120 includes or may access database 126. Database 126 may store various identifiers associated with client device 110 and/or other devices and/or servers that may engage and/or interact with accounts, computing services, and/or data collection processes 124. Database 126 may also store account data, including payment instruments, financial information, account balances, and authentication credentials, as well as transaction processing histories and data for processed transactions. Database 126 may include information for configuring of UI data fields 137 in UIs, which may include recent data provided or entered in data fields and/or previously provided or accessible data for a user (e.g., account data, PII, financial data, etc.). Although database 126 is shown as residing on service provider system 120 as a database, in other embodiments, other types of data storage and components may be used including cloud computing storage nodes, remote data stores and database systems, distributed database systems over network 140 and/or of a computing system associated with service provider system 120, and the like.

Service provider system 120 may include at least one network interface component 128 adapted to communicate with client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIGS. 2A-2D are exemplary diagrams 200a-200d for configuring data fields for data collection in a user interface for selection and personalized acquisition of user data, according to an embodiment. Diagrams 200a-d may include components of service provider system 120 that may be utilized for selecting UI fields and elements to present to a user during a data collection process based on rules generated for policies for data requirements and collection, as discussed in reference to system 100 of FIG. 1. In this regard, diagrams 200a-d may represent the interactions, flow, and execution of API calls and the like between such components when determining UI elements and UI field for data acquisition in a selective and personalized manner based on previous user input, a user profile or other known user information, and available computing services and products of a service provider.

Referring now to diagram 200a of FIG. 2A, collection optimization engine 133 may include an intelligent data acquisition system 202 utilized by service provider system 120 prior to or when client device 110 is engaged in one or more of data collection processes 124 to selectively configure UIs 132 with UI data fields 137 for data collection required by a computing service, product, or the like provided by a corresponding service provider. As such, intelligent data acquisition system 202 may determine UI elements and presentation of UI data fields 137 to collect and acquire data for data requirements of policies of the corresponding services and products. In contrast to generic UIs for data collection, intelligent data acquisition system 202 may create a UI that is customized for the user to avoid and minimize repetitive inputs, as well as streamline data collection for other computing services and products that may be offered or cross-promoted based on similar data requirements. As such, intelligent data acquisition system 202 may receive a request for an onboarding or other use of a computing service or product from client device 110 and prepare UI data fields 137 to customize data collection experiences 131 and provide data collection interfaces 113 on client device 110 for collection of user data 114. This may be performed and output by intelligent data acquisition system 202 in real-time as a user engages with data collection processes.

In this regard, a policy data collection layer 204 may be used to collect policies for rule generation. Policy data collection layer 204 may utilize web, mobile, and other applications to collect data from different sources regarding users, merchants, and/or other entities that may be used to verify those users, merchants, or entities for certain computing services and/or products, such as to verify identities, financial data, business information, or the like, authenticate users, authorize users or entities for extension of services or products (e.g., underwriting), and the like. Data may be stored in customer profiles, which may be made available for processing by intelligent data acquisition system 202. Data may also be collected and/or configured for a product catalog, which may include computing services and other products offered by the service provider with their corresponding data requirements and other information for processing by intelligent data acquisition system 202 when configuring data collection and cross-promoting or offering other products to users during data collection.

A policy aggregation layer 206 may be used to aggregate and combine policies from a policy information layer 208. In this regard, policies may be established by a service provider that offers products to users and/or corresponding entities (e.g., merchants, businesses, etc.), and may correspond to policies set for collecting data that may be utilized and/or processed to determine eligibility, qualification, and/or provision of the product to the users and/or entities. For example, policies set under policy information layer 208 may include data requirements of computing services and/or products for their eligibility and/or provision including user authorization, verification, etc. Policies may be associated with a risk data requirement provider, a compliance data requirement provider, and/or a verification provider, such as risk and/or compliance policies, user verification policies, and the like. Policy aggregation layer 206 may collect the policies in text for other processable form, including any directed graphs or flowcharts, and may provide the abstract requirements for the policies to intelligent data acquisition system 202 for processing.

As such, intelligent data acquisition system 202 may receive customer profiles, product catalogs, and policies for intelligent rule synthesis and generation, as well as additional information 210 from databases for customer activity and/or offered products that may be used with customer profiles and/or product catalogs, respectively. Intelligent data acquisition system 202 may utilize a conditional tree builder 212 to build conditional trees from the abstract requirements of policies by converting those requirements in text or other form to conditional trees, for example, using an AI engine (e.g., a natural language processor (NLP), LLM, and/or other language processor). The output trees may include conditions for data collection, such as what data may be required by different dependencies on that data for the policy. The output from conditional tree builder 212 may be provided to a logic tree merger 214 for merging. Logic tree merger 214 may merge the conditional trees by their overlapping conditions, keeping non-overlapping conditions in the trees with identification of their policies and products for service provision. These merged trees may correspond to rules for data collection that may be used by the service provider during data collection UX configuration and product recommendation. As such, a data recommendation ML model 216 and/or a product recommendation ML model 218 may utilize the rules generated from logic tree merger 214 to determine UI field selection and configuration in one or more UIs for data collection. A data correlation analyzer 220 may then be used to correlate previously provided data to conditions of the rules and determine when data has been provided to avoid duplicate data input and/or data duplication. FIGS. 2B and 2C show more detailed representations of intelligent data acquisition system 202 below.

In diagram 200b of FIG. 2B, an input 222 of policies 242 is provided for rule generation and data field recommendation during data collection and acquisition in a selective, personalized, and intelligent manner. In this regard, input 222 may be received from a user or may be automatically retrieved from a data repository of policies 242 that have been provided, collected, and/or stored for use by the data collection system for one or more computing services and/or products. For policies 242, two different crypto policies are shown for verifying a user to use for payment and/or transfer/trade cryptocurrency with a transaction processor. The requirements for the crypto policies vary between the two policies but may provide the same or similar authorization for cryptocurrency usage. For example, a user may verify for cryptocurrency usage, and therefore the system may collect data for usage of the service for cryptocurrency usage, data required by system 1 requirements using PII, as well as an identity document, while system 2 requirements may use the PII with an identity number or other national identification information. Policies 242 further include a savings account policy, where saving tax consent may be collected.

A conditional tree builder 212 may then be used to build conditional trees by parsing policies 242 using an NLP and/or LLM to extract and determine conditional statements or the like for data collection. For example, with conditional trees 244, a condition may correspond to a data dependency of the policy on data to be collected to satisfy the policy, or otherwise meet the conditions for the policy to be satisfy or fulfilled for provision of the computing service or product, authorization or verification of the user, financial data, or the like, or otherwise authorize the requested use of the computing service or product by the user. As such, for system 1 requirements for a crypto policy, a condition may be that if the customer type=personal account, then a name, address, and date of birth (DOB) are to be collected, then if the address is in the United States or Canada, a national identity document is to be collected, but if not, another document may be collected. Similar conditional statements for data collection may be generated for the other crypto policy, and savings account policy may be generated in a tree that represents the flow of data acquisition and collection for the policy.

As such, conditional tree builder 212 may utilize NLP, generative AIs (e.g., LLMs or the like), and/or other AI models and engines to create conditional trees 244. An output 224 of conditional trees 244 may be provided to logic tree merger 214 for merging by their overlapping (e.g., the same or similar) conditions so that a unified or merged conditional tree may be determined and used for data collection. Output 224 may include coded statements, data packages, or other computing code for conditional trees 244 that may be processed by logic tree merger 214. Logic tree merger 214 may include an AI model and/or engine to parse, traverse, and process conditional trees 244 to identify overlapping conditional statements and data collection requirements, such as the same or similar dependencies on data by conditional trees 244, and therefore policies 242. This may be used to generate a merged conditional tree 246 having conditional trees 244 merged based on having the same or similar conditions for data collection and the corresponding data to be collected. As such, merged conditional tree 246 may be used to represent multiple policies more efficiently, while also including different data requirements by different policies that may have other overlapping requirements, such that cross-promotion and/or offers may be determined. For example, if a user has provided 5 of 6 data requirements for a computing service while onboarding for another computing service, the user may be offered or promoted that service and informed that the user may submit the missing 6^{th} data requirement for processing to determine eligibility for the service.

Merged conditional tree 246 may be generated as one or more coded statements or data packages that may be utilizable with an AI engine, such as an adaptive learning AI engine, to configure UI field or other element presentation during data collection processes. Merged conditional tree 246 may therefore correspond to a rule for data collection, where the rule may specify the data to be collected for one or more computing services or products to be authorized and/or provided, as well as the additional related data that may be collected for other services and products that may be cross-promoted or offered during data collection (e.g., due to their overlapping data requirements). An output 226 of merged conditional tree 246 and/or the corresponding coded rule may then be provided to a data fields recommendation system 228 shown in diagram 200c of FIG. 2C for processing and use with UXs and data fields in UIs for data collection processes.

In diagram 200c of FIG. 2C, data fields recommendation system 228, which may correspond to the processes and/or components of collection optimization engine 133 to configure UI data fields 137 for data collection experiences 131, may process output 226 from logic tree merger 214 for rules for data collection optimization. Data fields recommendation system 228 may detect a user is entering and/or engaged with a data collection process, such as if the user is onboarding for an account, computing service or product usage or receipt, or otherwise providing user, business, financial, or other data for some verification, authorization, or the like. This detection may be from the user entering a data processing flow for the data collection process, performing a click-through or navigation event, entering data, or the like. As such, data fields recommendation system 228 may determine that a customization and personalization of UIs and UI data fields presented in the UIs may provide a more optimized UX for data collection, which simplifies the inputs, reduces duplicate data input and data duplication, and provides cross-promotion opportunities based on the rules (e.g., merged conditional tree 246) generated from policies 242.

In this regard, an output 230 of data fields recommendation system 228 may correspond to data fields selected for data collection. Further, based on the rules, user profile or other user information, previous input by the user, and the like, a product recommendation ML output 232 may recommend products for the user. For example, if the user is onboarding for crypto transactions and trades, the user may be recommended a savings account for saving and holding additional funds for cryptocurrency trading, which may be verified using the data provided when onboarding for the crypto transactions and/or additional data required by merged conditional tree 246 and its rule. Output 230 from data fields recommendation system 228 and product recommendation ML output 232 may be correlated by an AI engine to determine correlated data fields 234 for data requirements and product recommendations. Correlated data fields 234 may correspond to a set of data fields from a component factory or other repository of available data fields, where the set may be selected specifically to collect the data required for the policy in an optimized and efficient manner, avoiding data duplication, as well as collect or offer to collect data for other computing services and products recommended to the user. An output 236 shows the data fields to collect PII, such as an address, DOB, phone number, identity documents, national identity numbers or identifiers, or the like for verification of the user for the crypto service or product provision, but output 236 may also include a data field to collect a savings tax consent for a savings account that is a recommended product offering for the user.

In diagram 200d of FIG. 2D, rules may be generated and used to configure UXs and UIs for data collection during data collection processes for personalized and selective data acquisition. Rules may be determined using one or more AI models of collection optimization engine 133 trained for rule synthesis and output (e.g., an LLM or other generative AI) based on the policies of the service provider. Using the rules with previous user inputs, a customer profile, and/or product catalog, UIs in a UX for data collection and acquisition may be dynamically changed, updated, reconfigured, and/or used to create a new UX in real-time and/or during data acquisition for a customized and personalized data collection experience. This may be done to collect data more efficiently and for additional computing services and/or products while eliminating or reducing unnecessary user inputs and data processing. As such, initially in diagram 200d, policies are collected at 252 from different policy resources and/or repositories. Policy collection may include collection of policies for data and/or user verification, compliance, risk, and the like, which may be associated with laws, rules, and/or regulations governing computing service and/or product provision, usage, and the like.

Data is collected at 254 that may include data for users and/or entities (e.g., for which users may be providing data) that may be utilizing or have utilized a data collection and/or acquisition process. Data collection may include available data from user profiles, such as preexisting, known, or available user, merchant, or entity data that was previously provided, stored in a profile of the user/entity, or the like. Data collection may be used to determine if any data has been previously provided to avoid duplicate data input and/or data duplication. Data collection may create and/or store data to customer profiles and the like for retrieval by collection optimization engine 133.

Trees are then generated at 256 that may process policies from policy collection to create conditional trees, which may be coded and/or graphed in a computing code language, graph language or representation, or the like. Conditional trees may relate conditions for data acquisition, such as when certain data is required to be collected or should be requested and acquired. As such, conditions may correspond to data dependencies on collection of certain data to provide a computing service or product, as may be required by the corresponding policies. In this regard, an NLP or other language model (e.g., LLM or generative AI) may parse and process policy language and/or statements to create conditional trees and tree-based graphs or representations having conditions. The conditional trees are then converted to rules at 258 in executable code for a rule engine and/or ML model, which may be used for determination of UI field selection for data collection and acquisition. Rule conversion may generate rules by merging conditional trees based on the same or similar conditions that overlap, retaining different conditions for corresponding products and policies.

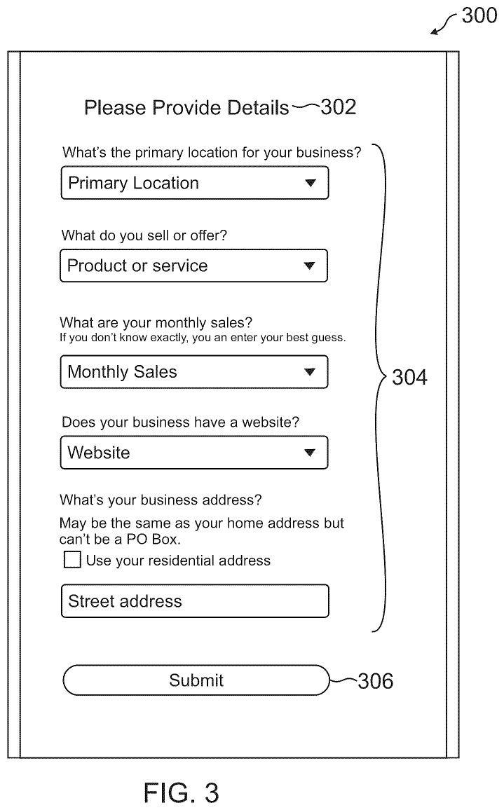

Collection optimization engine 133 may then utilize the rules corresponding to the merged trees to configure data collection processes at 260. Data collection configuration may utilize previously acquired data from data collections to determine which UI fields may be required to acquire data for the corresponding computing service or product being requested and/or onboarded for via the data collection process being used. Data collection configuration may select one or more UI fields or other elements, and specifically configure one or more UIs to output or present those elements during a UX for data collection. As such, a configured UI output 262 may present those configured UI(s) during a data collection UX provided to a user, as may be shown in the following FIG. 3.

FIG. 3 is an exemplary user interface (UI) 300 having data fields configured to collect and acquire user data in a selective and personalized manner using adaptive learning, according to various embodiments. UI 300 may correspond to one of data collection interfaces 113 on client device 110 in system 100 of FIG. 1, which may be presented from data collection processes 124 of service applications 122 during one of data collection experiences 131 specifically configured to collect data based on rules for data requirements. UI 300 may therefore have UI data fields 137 specifically configured to collect and acquire data for a computing service or product based on the rules, which may also include data acquisition for other products of interest, relation, or cross-promotion to the user. As such, UI 300 may include a customization of UI data fields 137 based on rules for policies of a service provider and a state of the UX including input entered and available data.

UI 300 may include an informational request 302 for user data that may be collected via data fields 304 selectively configured by collection optimization engine 133 as previously discussed. In this regard, informational request 302 may be presented during one of data collection experiences 131 that has been personalized for a user in order to streamline and simplify a data collection process based on previously provided input, known or available user data, and rules for data requirements for corresponding computing services, products, and their policies. This may further provide additional data collection for determination of cross-promotions and other services or products that may be of interest or usefulness to the user. In this regard, the user may view an informational request 302 for data collection where data fields 304 have been dynamically configured, such as in real-time and/or during the corresponding UX for data collection, to present and output the particular fields necessary for collecting the user data required by one or more policies. A determination of data fields 304 to present in real-time to the user may be based on rules created from conditional trees generated from policies, which may be merged from multiple policies for different products or services such that overlapping data may be collected together, and non-overlapping data may be identified and requested for computing service or product provision.

For example, data fields 304 may require information regarding a business of a merchant, such as a location, sale of products or services, monthly sales, a website, and/or a business address. Provision of input to data fields 304 may allow for verification of a merchant and therefore authorization to use or be provided a computing service or product, as required by certain policies of the service provider requesting the data via data fields 304. Thus, the merchant and/or user may provide the requisite information or confirmed prefilled information to verify onboarding. For example, data fields 304 may be used for underwriting and authorization of a credit balance to provide the merchant. However, data fields 304 may also be used to determine if the merchant qualifies for a chargeback protection or other corresponding risk protection product of the service provider, and as such, the rules for configuring data fields 304 may cause one or more fields to be included to collect data for that product. Data fields 304 may be selectively determined and configured in UI 300 based on the rules in real-time so that the user may submit information via a submission button 306 or other option and may proceed through the UX for onboarding and/or data collection.

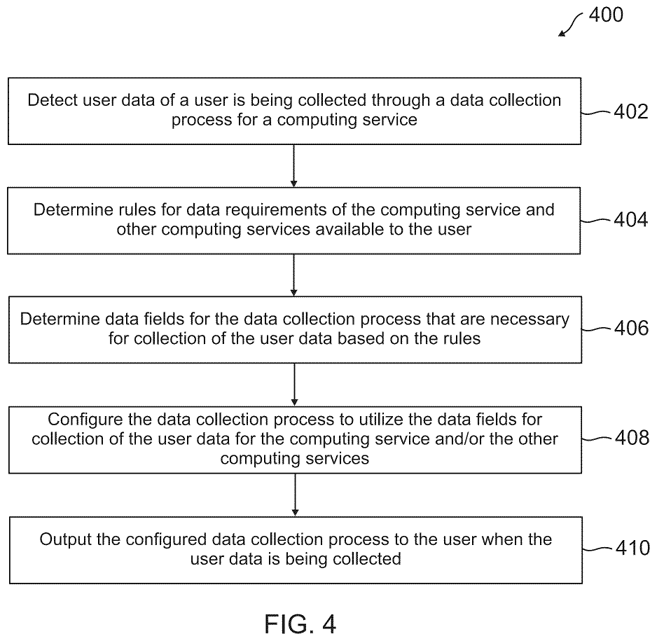

FIG. 4 is a flowchart 400 for selective and personalized acquisition of user data using adaptive learning, according to an embodiment. Note that one or more steps, processes, and methods described herein of flowchart 400 may be omitted, performed in a different sequence, or combined as desired or appropriate.

At step 402 of flowchart 400, user data of a user is detected as being collected through a data collection process for a computing service. For example, in system 100 of FIG. 1, client device 110 may be used to engage with service provider system 120 through service applications 122 or other computing services, products, and platforms of service provider system 120, which may require acquisition of data from client device 110 by service provider system 120. This may occur when a user initiates or proceeds through an onboarding flow for onboarding with a service or product or may request use of further services from service provider system 120. As such, it may be determined that the user has begun a process to provide user data and/or has already provided certain user data from previous activities, during the current data collection process, or integrations with other data resources, profiles, and the like of the user. As such, customization of data fields for user data entry may be selectively configured and presented for personalized data collection that minimizes unnecessary inputs and allows for cross-promotion of additional services and/or products.

At step 404, rules for data requirements of the computing service and other computing services available to the user are determined. In this regard, data collection platform 130 may, previously and/or at periodic time intervals, generate and/or update UI rules 136 for use of different data fields utilized to collected data for data requirements of the service provider, the computing service and/or product, and/or laws, rules, and/or regulations governing the data to be collected and/or the service to be provided. In this regard, policies and procedures of the service provider may require certain data to be acquired from users when providing the users with corresponding computing services and products. For example, user data may be required to verify an identity and/or financial data of the user, run risk and/or underwriting for the user, determine authentication credentials and/or authenticate the user, or otherwise collect and/or process data for conditions of data collection, where the conditions correspond to data dependencies for satisfying the data requirements. Policies may be associated with laws, rules, or regulations for certain products and/or computing services including underwriting, data privacy, consumer protection, and the like. Policies may also be associated with risk models and/or fraud systems. Policies may be stored to a repository or other database and accessible for rule synthesis.

Rule processor 135 may synthesize and create rules from data collection policies 134 using creation and merging of conditional trees by parsing the individual policies. Once parsed, rule processor 135 may create a conditional tree for each policy having conditions for data collection, where each condition corresponds to a dependency of data to be collected as required by the data requirements of the policy. The conditional trees may link conditions via their order and/or flow for data collection. Once generated, the trees may be merged based on the same or similar conditions, where branches for non-overlapping conditions may remain and represent a merged tree that represents how data may be collected for multiple of the same or similar data requirements, and their corresponding computing services or products. As such, each merged conditional tree may be used to determine what conditions for data collection and required, and therefore what data fields or other UI elements may be used to collect data in an optimized manner for a computing service and related computing services that may be cross-promoted and offered. Creation of conditional trees and merging of trees may be performed using an AI engine that may be used to determine conditions and data dependencies, as well and merge conditions that overlap for conditional tree building and use for UI field selection and UI customization for data collection.

At step 406, data fields for the data collection process that are necessary for collection of the user data based on the rules are determined. Based on the merged conditional trees for UI rules 136, collection optimization engine 133 may configure UIs 132 in data collection experiences 131 to have specifically selected fields or elements from UI data fields 137. To do this, collection optimization engine 133 may determine which UI fields have already been completed or have input previously entered, and what data may be necessary to complete, fulfill, or satisfy the data requirements for provision of the computing service and/or product. Collection optimization engine 133 may also determine the data necessary to be collected, and those corresponding UI fields, based on previously provided data by the user, available data for the user from other data resources, and the like. An AI engine may utilize the known data to determine the data requirements to be collected and fulfilled and may therefore be used to select from UI data fields 137 for data collection. Based on the data to be collected, UI data fields 137 used to collect this data may be determined.

At step 408, the data collection process is configured to utilize the data fields for collection of the user data for the computing service and/or the other computing services. Once one or more of UI data fields 137 used to collect the data are determined, UIs 132 for data collection experiences 131 to be utilized by service applications 122 may be specifically tailored by collection optimization engine for data collection in an optimized, efficient, and predictive manner. To do so, an AI engine of and/or used by collection optimization engine 133 may select from UI data fields 137 those fields required to complete data collection for the computing service or product, as well as other services or products that may be cross-sold or offered due to overlap, similarities, and/or user interest.

At step 410, the configured data collection process is output to the user when the user data is being collected. In this regard, UI data fields 137 for UIs 132 configured for data collection experiences 131 may be output via service application 122 for use by client device 110. As such, when client device 110 accesses data collection processes 124 for a UX, UI data fields 137 may be specifically output based on the configuration of data collection experiences 131 for the corresponding data to be collected. Client device 110 may then view data collection interfaces 113 and may provide user data 114. In some embodiments, data collection interfaces 113 may include preloaded or prefilled portions of user data 114 and may display one or more of UI data fields 137 specifically selected for the user based on their previous input, available data, and the like. Note that while flowchart 400 is described with respect to user data collection, similar concepts, as discussed herein, can be used for configuring any data collection processes for different users, entities, computing services, and/or products that may require collection of data.

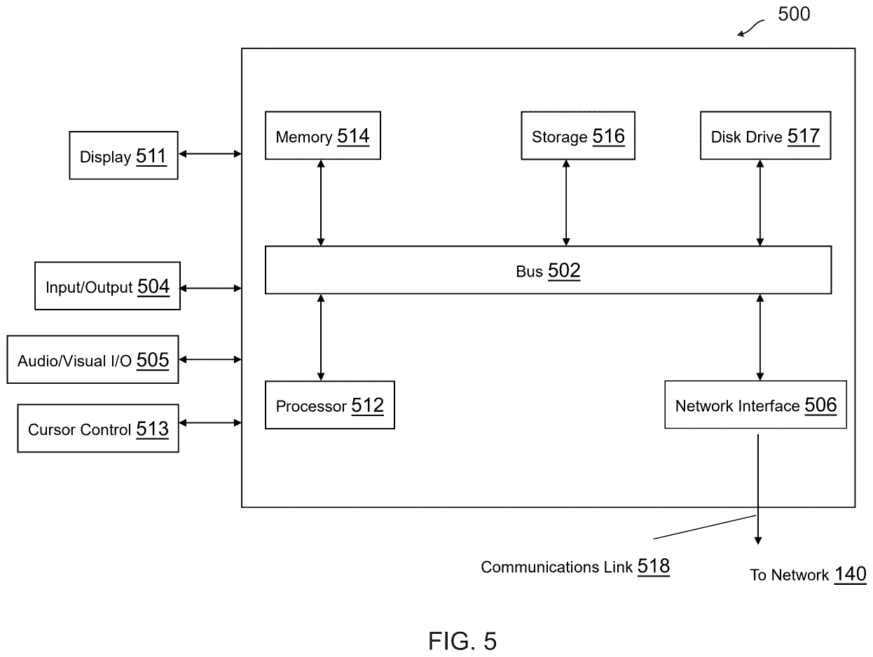

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to execute instructions to cause the service provider system to:
detect first user data of a user being collected via a user interface (UI) during a data collection process by the service provider system for a computing service offered by the service provider system to at least the user;
identify a plurality of data fields utilized for collecting the first user data via the UI during the data collection process;
determine a plurality of rules associated with data requirements for providing the computing service to the user, wherein the plurality of rules designate whether each of the plurality of data fields is required for computing service;
determine a subset of the plurality of data fields for the data collection process based on the plurality of rules and a user profile of the user, wherein the subset of the plurality of data fields excludes at least one of the plurality of fields;
configure the data collection process based on the subset of the plurality of data fields; and
output the configured data collection process via the UI on a device of the user.

2. The service provider system of claim 1, wherein the data collection process is performed for one of an account creation for the computing service or an onboarding of an account for the computing service, and wherein the first user data comprises one of new user data for the account creation or an update to second user data previously received and associated with the user profile of the user.

3. The service provider system of claim 1, wherein, prior to detecting the first user data, executing the instructions further causes the service provider system to:
access a plurality of policies associated with the data requirements for providing the computing service to the user; and
generate the plurality of rules using conditional trees synthesized from the plurality of policies.

4. The service provider system of claim 3, wherein the plurality of policies comprises at least one of a risk policy for risk assessments of users, an authorization policy for providing the computing service to the users, or a compliance policy for legal requirements associated with the computing service.

5. The service provider system of claim 3, wherein generating the plurality of rules comprises:
converting the plurality of policies into the conditional trees, wherein the conditional trees have conditions for collecting the data requirements in accordance with the plurality of policies, and wherein the conditions have corresponding dependencies on certain data for satisfying the data requirements.

6. The service provider system of claim 5, wherein the conditional trees include at least one merged conditional tree from two or more initial conditional trees sharing one or more of the conditions and one or more of the corresponding dependencies.

7. The service provider system of claim 1, wherein executing the instructions further causes the service provider system to:
determine a submission by the user usable to complete at least a portion of the data requirements based at least one of the subset of the plurality of data fields or the user profile; and
request the submission via the UI.

8. The service provider system of claim 7, wherein executing the instructions further causes the service provider system to:
determine an additional computing service or a product of the service provider system available to the user after verifying the submission; and
offer the additional computing service or the product to the user via the UI in association with requesting the submission.

9. The service provider system of claim 1, wherein outputting the configured data collection process comprises rendering the UI having the subset of the plurality of data fields customized specifically for the user in real-time during the data collection process.

10. A method comprising:
accessing policy information associated with a service provider, wherein the policy information indicates data requirements of the service provider for providing computing services to users of the service provider;
generating, based on the policy information, a plurality of conditional trees for a plurality of policies corresponding to the data requirements, wherein each of the plurality of conditional trees includes at least one condition for data collection and a corresponding data type collected for the at least one condition;
converting the plurality of conditional trees to a code language usable with a data collection process;
merging corresponding ones of the plurality of conditional trees based on corresponding ones of the at least one condition and the corresponding data type in each of the plurality of conditional trees;
configuring a plurality of rules for the data collection process based on resulting conditional trees from the merging, wherein the plurality of rules is configured to change data fields for the data collection process based on user profiles and the data requirements; and
outputting one or more of the data fields during the data collection process for one of the computing services to a user based on a user profile of the user and the plurality of rules.

11. The method of claim 10, wherein the data collection process is based on a user experience (UX) implementing a user interface (UI) having the one or more of the data fields, and wherein, prior to the outputting the one or more of the data fields, the method further comprises:
configuring the UI to have the one or more of the data fields for the UX personalized for the user based on the user profile and the plurality of rules,
wherein the outputting the one or more of the data fields comprises outputting the configured UI.

12. The method of claim 11, wherein the configuring the UI is further based on a previous user input provided by the user during the data collection process.

13. The method of claim 11, wherein the UX is associated with an onboarding for a computing service or a product provided to the user.

14. The method of claim 10, wherein the outputting comprises dynamically rendering a UI having the one or more of the data fields in real-time during the data collection process.

15. The method of claim 10, wherein each of the resulting conditional trees is associated with a subset of computing services having overlapping ones of the data requirements.

16. The method of claim 15, further comprising:
providing an additional one of the data fields for another one of the computing services offered to the user during the data collection process.

17. The method of claim 10, wherein the policy information is associated with at least one of a risk policy, an authorization policy, or a compliance policy of the service provider.

18. The method of claim 10, wherein the user profile comprises available user data for the user from one or more online resources.

19. A non-transitory machine-readable medium having stored thereon machine-readable instructions executable to cause a machine to perform operations comprising:
detecting a user is providing an input associated with user data via a data collection process of a service provider, wherein the data collection process is associated with a user experience (UX) that includes a first user interface (UI) having one or more data fields usable to collect the user data;
determining a plurality of rules associated with data requirements for the service provider, wherein the data requirements designate different portions of the user data required for verifying provisions of different computing services to the user, and wherein each of the plurality of rules corresponds to a conditional tree indicating one or more conditions for collecting at least a portion of the user data for one or more of the data requirements;
selecting a subset of the one or more data fields for the data collection process based on the plurality of rules, available data for the user, and the input currently provided by the user;
creating a second UI for the UX based on the subset of the one or more data fields; and
configuring the data collection process based on the UX having the second UI.

20. The non-transitory machine-readable medium of claim 19, wherein the second UI comprises a dynamic configuration of the first UI performed in real-time while the user is providing the input via the data collection process.
